(19) United States
(12) Patent Application Publication
(10) Pub. No.: US 2019/0109339 A1
(43) Pub. Date: Apr. 11, 2019

(54) FUEL CELL SYSTEM

(71) Applicant: TOYOTA JIDOSHA KABUSHIKI KAISHA, Toyota-shi (JP)

(72) Inventor: Makoto TAKEYAMA, Toyota-shi (JP)

(73) Assignee: TOYOTA JIDOSHA KABUSHIKI KAISHA, Toyota-shi (JP)

(21) Appl. No.: 16/152,892

(22) Filed: Oct. 5, 2018

(30) Foreign Application Priority Data
Oct. 10, 2017 (JP) 2017-197148

(51) Int. Cl. H01M 8/04746; H01M 8/04223; H01M 8/0662

(52) U.S. Cl. CPC H01M 8/04761; H01M 8/0662; H01M 8/04253

(57) ABSTRACT

Provided is a fuel cell system that ensures the operation and opening of a valve body that is frozen and stuck, even when liquid that has collected inside the system is frozen, and that is thus highly reliable. The valve body, when closed, is disposed so as to be tilted relative to the vertical plane so that a valve body surface facing upstream of an oxidant gas flow in an oxidant gas discharge channel faces up, and the lower portion of the valve body, which is located at a lower level in the gravity direction when the valve body is closed, is adapted to open toward a downstream side of the oxidant gas flow in the oxidant gas discharge channel.

### CROSS REFERENCE TO RELATED APPLICATIONS

The present application claims priority from Japanese patent application JP 2017-197148 filed on Oct. 10, 2017, the content of which is hereby incorporated by reference into this application.

### BACKGROUND

### Technical Field

The present disclosure relates to a fuel cell system.

There have conventionally been known fuel cell systems that include fuel cells (a fuel cell stack) that generate electricity through electrochemical reactions of reactant gases, between an oxidant gas such as air and a fuel gas such as hydrogen.

In the fuel cell system of this type, upon termination of the operation of the fuel cells, scavenging treatment (purge treatment) is typically performed by controlling the components of the fuel cell system so as to reduce water remaining in the fuel cells or being stuck to pipes, valves, and the like of the fuel cell system. This reduces the amount of water inside the fuel cells in a fuel-cell vehicle, so that excellent start-up performance is ensured even in a low temperature environment.

However, even when such scavenging treatment (purge treatment) is performed, water such as water remaining after the scavenging treatment, remaining water from the fuel cells (fuel cell stack), or water resulting from dew condensation still collects around valve bodies and valve seats of valves (in particular, valves disposed in an oxidant gas discharge channel for discharging, from the fuel cells, an oxidant off-gas that is produced after an oxidant gas is used for an electrochemical reaction in each fuel cell and in a fuel gas discharge channel for discharging, to the outside (releasing to the air), a fuel off-gas (unconsumed fuel gas) that is discharged from the fuel cells). This causes the valve bodies to freeze and to be stuck in a low temperature environment, thereby possibly posing a problem of difficulty in opening the valve bodies at the start-up at a low temperature.

To address such a problem, JP 2015-014331 A, for example, suggests a fluid control valve that controls the flow rate of a fluid flowing through a channel by causing a valve shaft to which a valve body is attached to ascend and descend so as to allow the valve body to move away from and come into contact with a valve seat, and thus opening and closing the channel, in which the valve shaft is tilted relative to the horizontal plane, and a wall portion is formed along an upper surface edge portion of the valve body that corresponds to a portion where liquid inside the channel collects due to the weight thereof, within a portion where the valve seat is formed.

According to the background art described in JP 2015-014331 A, when liquid (for example, water) inside the channel collects in a portion (for example, the lowest portion) of the channel while the valve body is in contact with (sits on) the valve seat, the wall portion formed along the upper surface of the valve body can prevent the water that has collected from spilling over the upper surface portion of the valve body (permeating beyond the upper surface of the valve body), and thus, even when the water that has collected is frozen in a low temperature environment, the frozen and stuck valve body can be easily operated.

### Background Art

However, in the background art described in JP 2015-014331 A, a problem may arise that since the valve body opens toward the frozen liquid (ice) side, if the liquid that has collected around the valve body and valve seat is frozen, the opening operation of the valve body is hindered by the frozen liquid (ice), and thus the valve body becomes unmovable (becomes unable to open).

The present disclosure has been made in view of the aforementioned problem, and provides a fuel cell system that ensures the operation and opening of a valve body that is frozen and stuck, even when the liquid that has collected inside the system is frozen, and that is thus highly reliable.

### SUMMARY

In order to solve the aforementioned problem, according to the present disclosure, there is provided a fuel cell system including a fluid control valve in a reactant gas discharge channel through which a reactant gas discharged from fuel cells flows, the fluid control valve having a valve body, the valve body being adapted to open and close the reactant gas discharge channel, in which the valve body, when closed, is disposed so as to be tilted relative to the vertical plane so that a valve body surface facing upstream of a reactant gas flow in the reactant gas discharge channel faces up and a lower portion of the valve body that is located at a lower level in the gravity direction at least when the valve body is closed is adapted to open toward a downstream side of the reactant gas flow in the reactant gas discharge channel

Further, the fuel cell system according to the present disclosure includes the fluid control valve in the reactant gas discharge channel through which a reactant gas discharged from the fuel cells flows, the fluid control valve being adapted to open and close the reactant gas discharge channel by rotating a plate-like valve body about a rotating shaft, in which the rotating shaft is horizontally disposed and the valve body, when closed, is disposed so as to be tilted relative to the vertical plane so that the valve body surface facing upstream of a reactant gas flow in the reactant gas discharge channel faces up and the lower portion of the valve body that is located at the lower level in the gravity direction when the valve body is closed is adapted to open toward a downstream side of the reactant gas flow in the reactant gas discharge channel.

In some embodiments, the valve body is disposed such that when the valve body is closed, the valve body surface facing upstream of the reactant gas flow in the reactant gas discharge channel is tilted at an angle in the range of 10 to 45 degrees relative to the vertical plane.

In some embodiments, the reactant gas discharge channel is disposed so as to be constantly tilted downward in a region of from a discharge port of the fuel cell to the fluid control valve.

According to the present disclosure, since the valve body of the fluid control valve that is provided in and is adapted to open and close the reactant gas discharge channel is disposed so as to be, when the valve body is closed, tilted relative to the vertical plane so that the valve body surface facing upstream of the reactant gas flow in the reactant gas discharge channel faces up, liquid such as water that has flowed through the reactant gas discharge channel remaining after scavenging treatment, remaining water from the fuel cells (fuel cell stack), or water resulting from dew condensation tends to collect, due to the weight thereof, in the lower portion of the valve body in the gravity direction when the valve body is closed. Further, since the lower portion of the valve body, which is located at a lower level in the gravity direction at least when the valve body is closed, is adapted to open toward a downstream side of the reactant gas flow in the reactant gas discharge channel, even when the liquid that has collected therein is frozen, the valve body can move (open) in a direction of removing the frozen liquid (ice) along the downstream direction of the reactant gas flow in the reactant gas discharge channel, so that the movement of the valve body when it is opened is not hindered by the frozen liquid (ice). Thus, the operation and opening of the valve body that is frozen and stuck is ensured, thereby ensuring the open/close performance (valve opening performance) of the fluid control valve provided in the reactant gas discharge channel.

### BRIEF DESCRIPTION OF THE DRAWINGS

FIG. 1 is a system configuration diagram of a fuel cell system according to the present disclosure;

FIG. 2 is a rear view of the main portion of the fuel cell system according to the present disclosure;

FIG. 3 is a cross-sectional view taken along an arrow F-F of FIG. 2, showing a pressure regulating valve when it is closed; and

FIG. 4 is a cross-sectional view taken along an arrow F-F of FIG. 2, showing a pressure regulating valve when it is open.

### DETAILED DESCRIPTION

The, configuration of the present disclosure will be described below in detail based on an example of an embodiment shown in the drawings. As an example of the present disclosure, fuel cells or a fuel cell system including them to be mounted on a fuel cell vehicle will be described, but the range of application of the present disclosure is not limited thereto.

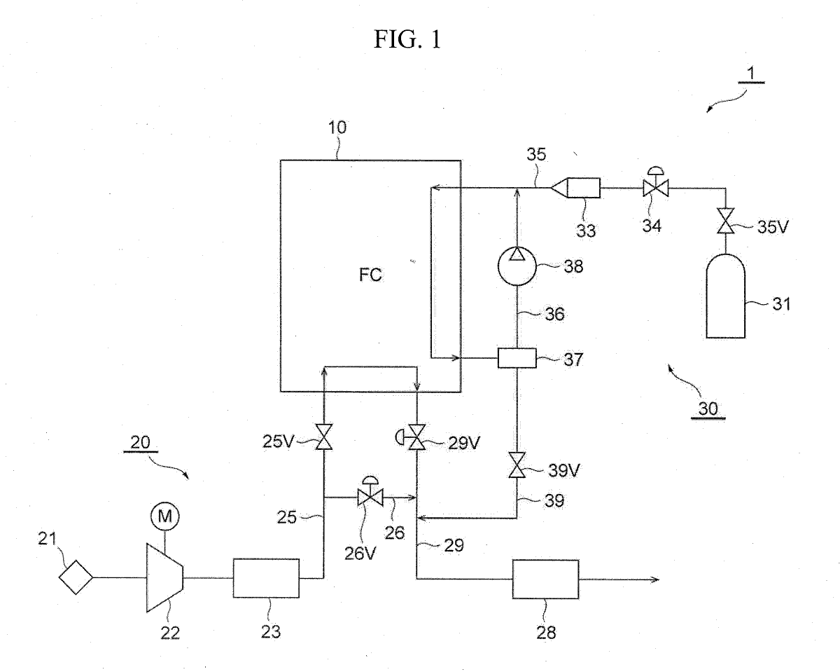

First, the system configuration of the fuel cell system with fuel cells according to the present disclosure will be outlined with reference to FIG. 1.

A fuel cell system 1 shown in FIG. 1 includes, for example, fuel cells (a fuel cell stack) 10 formed by stacking a plurality of fuel cells, each cell being a unit cell, an oxidant gas supply system 20 that supplies an oxidant gas such as air to the fuel cells 10, and a fuel gas supply system 30 that supplies a fuel gas such as hydrogen to the fuel cells 10.

For example, each of the fuel cells 10 as a polymer electrolyte fuel cell has a membrane electrode assembly (MEA) that includes an electrolyte membrane with ion permeability and anode-side catalyst layer (anode electrode) and cathode-side catalyst layer (cathode electrode) sandwiching the electrolyte membrane therebetween. The MEA has gas diffusion layers (GDLs) on opposite sides thereof for providing a fuel gas or an oxidant gas to the MEA and for collecting electricity generated through electrochemical reactions. Such a membrane electrode assembly having GDLs on opposite sides thereof is referred to as a MEGA (Membrane Electrode & Gas Diffusion Layer Assembly), and the MEGA is sandwiched between a pair of separators. Herein, the MEGA is a power generation portion of the fuel cell. If no gas diffusion layers are provided, the MEA is the power generation portion of the fuel cell.

The oxidant gas supply system 20 includes, for example, an oxidant gas supply channel (pipe) 25 for supplying an oxidant gas to the fuel cells 10 (or the cathode electrodes thereof), an oxidant gas discharge channel (pipe) 29 for discharging, from the fuel cells 10, an oxidant off-gas that is produced after the oxidant gas is used for an electrochemical reaction in each fuel cell, and a bypass channel 26 for circulating the oxidant gas supplied through the oxidant gas supply channel 25 to the oxidant gas discharge channel 29 by bypassing the fuel cells 10. Each channel of the oxidant gas supply system 20 may be made of, for example, a rubber hose or a metal pipe.

The oxidant gas supply channel 25 is provided with an air cleaner 21, an air compressor (turbo compressor) (hereinafter simply referred to as a compressor) 22, an intercooler 23, and the like that are arranged in this order from the upstream side, and the oxidant gas discharge channel 29 is provided with a muffler 28 and the like. It should be noted that the oxidant gas supply channel 25 (or the air cleaner 21 thereof) is provided with, for example, an atmospheric pressure sensor and/or an air flow meter (which are not shown).

In the oxidant gas supply channel 25, the air cleaner 21 removes dust in the oxidant gas (such as air) to be taken in from the atmosphere.

The compressor 22 compresses the oxidant gas introduced via the air cleaner 21 and pressure-feeds the compressed oxidant gas to the intercooler 23.

When the oxidant gas that has been pressure-fed and introduced from the compressor 22 passes through the intercooler 23, the intercooler 23 cools the oxidant gas through heat exchange with a refrigerant, for example, and supplies the cooled oxidant gas to the fuel cells 10 (or the cathode electrodes thereof).

Further, the oxidant gas supply channel 25 is provided with an inlet valve 25V for blocking an oxidant gas flow between the intercooler 23 and the fuel cells 10. It should be noted that the inlet valve 25V may be a check valve that is configured to open by the flow of the oxidant gas moving from the intercooler 23 toward the fuel cells 10 and thus allow the passage of the oxidant gas, and to close by the flow of the oxidant gas moving from the fuel cells 10 toward the intercooler 23 and thus block the passage of the oxidant gas.

The bypass channel 26 is connected to the oxidant gas supply channel 25 (or the intercooler 23 thereof or the downstream of the intercooler 23) at one end thereof, and to the oxidant gas discharge channel 29 at the other end thereof. In other words, the bypass channel 26 branches from the oxidant gas supply channel 25 (or the intercooler 23 thereof or the downstream of the intercooler 23) toward the oxidant gas discharge channel 29 and is connected thereto. In the bypass channel 26, the oxidant gas that has been pressure-fed by the compressor 22, cooled by the intercooler 23, and then discharged flows toward the oxidant gas discharge channel 29 by bypassing the fuel cells 10. The bypass channel 26 is provided with a bypass valve 26V for regulating the flow rate of the oxidant gas flowing through the bypass channel 26 by blocking the oxidant gas flowing toward the oxidant gas discharge channel 29.

In the oxidant gas discharge channel 29, the muffler 28 separates the oxidant off-gas (exhaust gas) flowing through the oxidant gas discharge channel 29 into, for example, gas and liquid phases so as to be discharged to the outside.

Further, the oxidant gas discharge channel 29 is provided with a pressure regulating valve 29V for regulating the back pressure of the oxidant gas supplied to the fuel cells 10. The aforementioned bypass channel 26 is connected to the downstream side of the pressure regulating valve 29V.

Meanwhile, a fuel gas supply system 30 includes, for example, a fuel gas supply source 31 such as a hydrogen tank that stores a high-pressure fuel gas such as hydrogen, a fuel gas supply channel (pipe) 35 for supplying the fuel gas fed from the fuel gas supply source 31 to the fuel cells 10 (or the anode electrodes thereof), a circulation channel 36 for refluxing a fuel off-gas (unconsumed fuel gas) discharged from the fuel cells 10 to the fuel gas supply channel 35, and a fuel gas discharge channel (pipe) 39, which branches from the circulation channel 36, for discharging the fuel off-gas inside the circulation channel 36 to the outside (releasing to the air). Each channel of the fuel gas supply system 30 may be made of, for example, a rubber hose or a metal pipe.

The fuel gas supply channel 35 is provided with, for example, a pressure gauge (not shown) for measuring the fuel gas pressure, and also with a shut-off valve 35V for blocking the fuel gas flowing toward the fuel cells 10 by opening and closing the fuel gas supply channel 35, a regulator 34 for regulating (reducing) the pressure of the fuel gas flowing through the fuel gas supply channel 35, and an injector 33 for supplying the fuel gas with its pressure regulated to the fuel cells 10. When the shut-off valve 35V is opened, the high-pressure fuel gas stored in the fuel gas supply source 31 flows out to the fuel gas supply channel 35, and is supplied to the fuel cells 10 (or the anode electrodes thereof) with its pressure regulated (reduced) by the regulator 34 and the injector 33.

The circulation channel 36 is provided with a gas-liquid separator 37, a circulation pump (also referred to as a hydrogen pump) 38, and the like that are arranged in this order from the upstream side (the side of the fuel cells 10).

The gas-liquid separator 37 separates the fuel gas (such as hydrogen), which contains produced water therein, flowing through the circulation channel 36 into gas and liquid and stores them. A fuel gas discharge channel 39 is provided so as to branch from the gas-liquid separator 37.

The circulation pump 38 pressure-feeds the fuel off-gas, which has been produced through the gas-liquid separation by the gas-liquid separator 37, to the fuel gas supply channel 35 to be circulated therethrough.

The fuel gas discharge channel 39 is provided with a purge valve 39V that is adapted to open and close the fuel gas discharge channel 39 so as to discharge the produced water, which has been separated from the fuel gas by the gas-liquid separator 37, and some of the fuel off-gas discharged from the fuel cells 10.

The fuel off-gas discharged through the adjustment of opening and closing of the purge valve 39V of the fuel gas discharge channel 39 is mixed with the oxidant off-gas flowing through the oxidant gas discharge channel 29 and then released to the air outside via the muffler 28.

In the fuel cell system 1 with the aforementioned configuration, electricity is generated through electrochemical reactions between an oxidant gas such as air supplied to the fuel cells 10 (or the cathode electrodes thereof) through the oxidant gas supply system 20 and a fuel gas such as hydrogen supplied to the fuel cells 10 (or the anode electrodes thereof) through the fuel gas supply system 30.

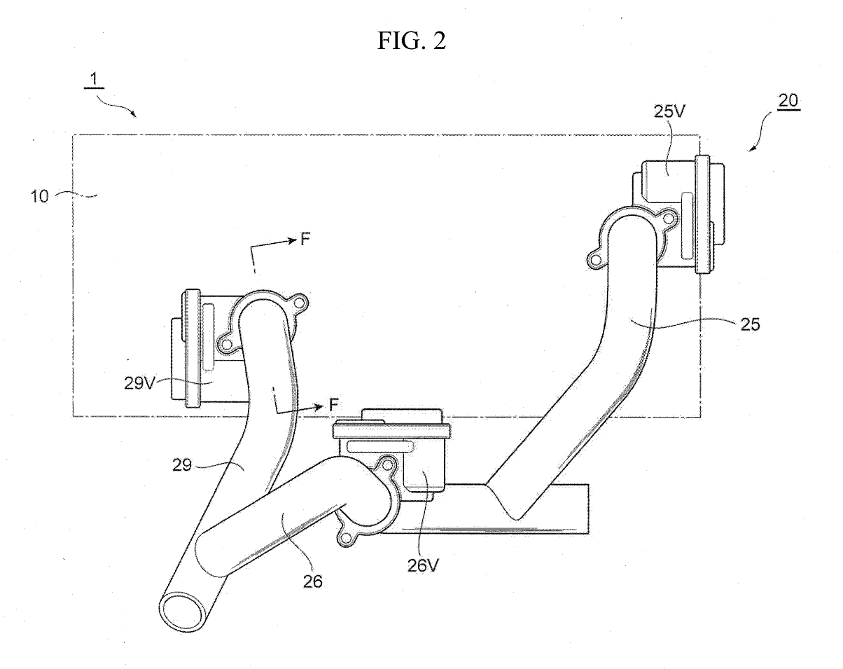

FIG. 2 is a rear view of the main portion of the fuel cell system according to the present disclosure.

The following description will be made with emphasis on the characteristic point of the present disclosure, which is the arrangement of a reactant gas discharge channel (the oxidant gas discharge channel 29 or the fuel gas discharge channel 39) through which a reactant off-gas (oxidant off-gas or fuel off-gas) discharged from the fuel cells 10 flows and a fluid control valve that regulates the flow rate of the reactant off-gas that flows through the reactant gas discharge channel by opening and closing it.

Further, although the following description will be mainly made of, as an example, the components of the oxidant gas supply system 20 of the fuel cell system 1, which are the oxidant gas discharge channel 29 and the pressure regulating valve 29V as a fluid control valve disposed in the oxidant gas discharge channel 29, it goes without saying that the present disclosure is also applicable to the components of the fuel gas supply system 30, which are the fuel gas discharge channel 39 and the purge valve 39V as a fluid control valve that is disposed in the fuel gas discharge channel 39.

As described above, the oxidant gas supply system 20 of the fuel cell system 1 of the embodiment shown in the drawing includes the oxidant gas supply channel 25 provided with the inlet valve 25V and the like, the oxidant gas discharge channel 29 provided with the pressure regulating valve 29V and the like, and the bypass channel 26 provided with the bypass valve 26V. It should be noted that each channel of the oxidant gas supply system 20 may be made of, for example, a rubber hose or a metal pipe.

Of the channels of the oxidant gas supply system 20, the oxidant gas discharge channel 29 is provided such that it extends substantially vertically downward of the fuel cells 10 (or the discharge port provided on the left side on the back thereof) disposed on the front side of a vehicle, for example, and is provided with the pressure regulating valve 29V near the fuel cells 10 (or the discharge port thereof).

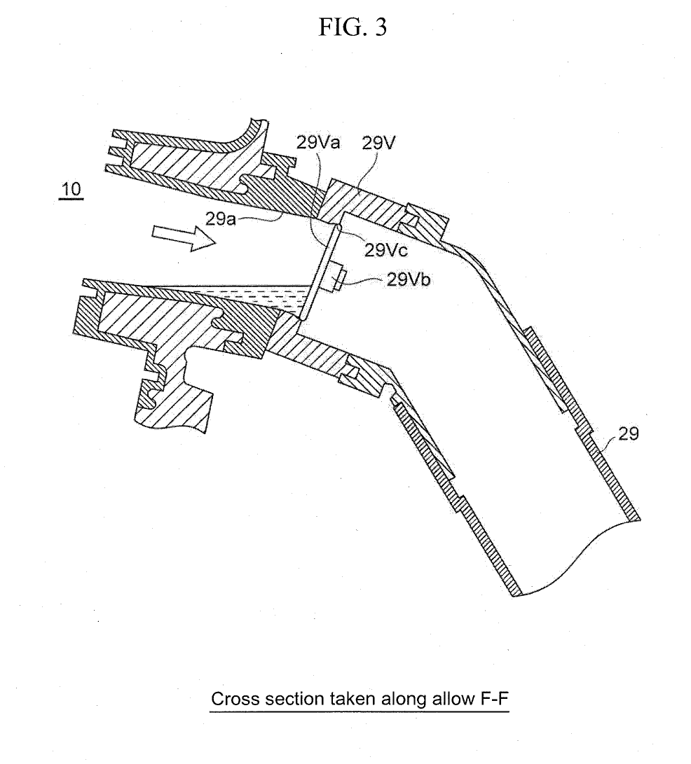

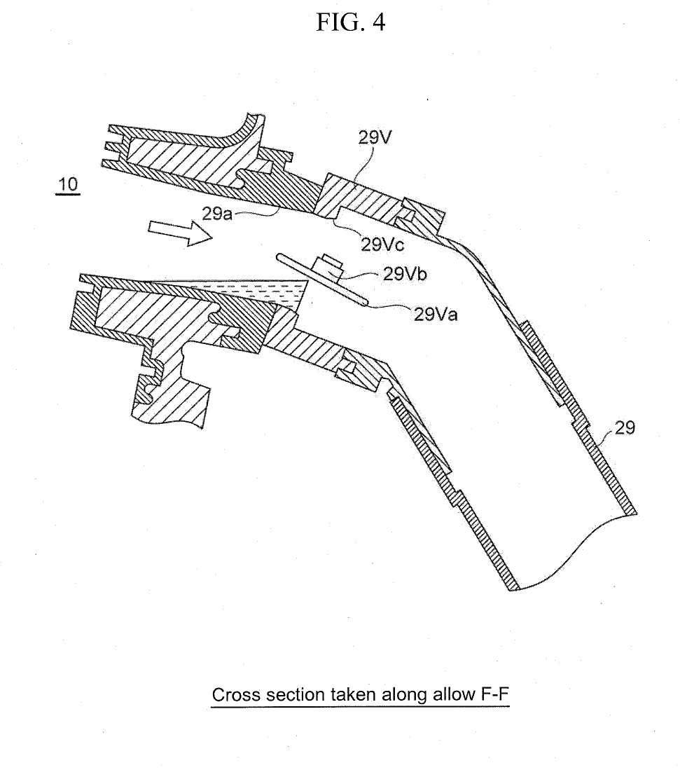

As clearly understood from FIGS. 3 and 4, the pressure regulating valve 29V herein is configured as a butterfly valve that is adapted to open and close the oxidant gas discharge channel 29 by rotating a disc-like valve body 29Va about a rotating shaft 29Vb. In the present example, the rotating shaft 29Vb of the pressure regulating valve 29V is supported (rotatably) horizontally and disposed eccentrically relative to the valve body 29Va (specifically, disposed so as to be offset toward the downstream side (the side opposite to the side of the fuel cells 10) of the oxidant gas flow in the oxidant gas discharge channel 29).

Further, in the pressure regulating valve 29V, an annular valve seat 29Vc, which the valve body 29Va (or the peripheral portion thereof) moves into contact with or away from, is provided so as to be tilted relative to the vertical plane, and the valve body 29Va is disposed so as to be tilted relative to the vertical plane so that the surface of the valve body 29Va on the side of the fuel cells 10 (in other words, the surface facing upstream of the oxidant gas flow in the oxidant gas discharge channel 29) faces up when the valve body is closed.

Herein, the tilt angle of the valve body 29Va (or the surface thereof on the side of the fuel cells 10) relative to the vertical plane when the valve body is closed is set to an angle in the range of, for example, 10 to 45 degrees, considering the amount of liquid (water) that would collect around the valve body 29Va and valve seat 29Vc of the pressure regulating valve 29V (specifically, portions on the side of the fuel cells 10 of the valve body 29Va and valve seat 29Vc of the pressure regulating valve 29V) as described above (see, in particular, FIG. 3).

Further, the valve body 29Va is configured such that when it is rotationally driven by a motor (not shown) provided externally to the oxidant gas discharge channel 29, its lower half portion (a portion below the rotating shaft 29Vb), which is located at a lower level in the gravity direction (the vertical direction) when the valve body is closed, opens toward the side opposite to the side of the fuel cells 10 (that is, toward the downstream direction of the oxidant gas flow in the oxidant gas discharge channel 29) as shown in FIG. 4.

Furthermore, in the present example, in order to prevent backflow of the liquid (water) that has collected around the valve body 29Va and valve seat 29Vc of the pressure regulating valve 29V toward the side of the fuel cells 10, a portion of the oxidant gas discharge channel 29 in a region of from the fuel cells 10 (or the discharge port thereof) to the pressure regulating valve 29V (or the valve body 29Va thereof) (a portion indicated by reference numeral 29a in FIGS. 3 and 4) is disposed so as to be constantly tilted downward.

As described above, in the fuel cell system 1 of the present embodiment, since the valve body 29Va of the pressure regulating valve 29V that is provided in and is adapted to open and close the oxidant gas discharge channel 29 is disposed so as to be, when the valve body is closed, tilted relative to the vertical plane so that the valve body surface facing upstream of the oxidant gas flow in the oxidant gas discharge channel 29 faces up, liquid such as water that has flowed through the oxidant gas discharge channel 29 remaining after scavenging treatment, remaining water from the fuel cells (fuel cell stack) 10, or water resulting from dew condensation tends to collect, due to the weight thereof, in the lower portion of the valve body 29Va in the gravity direction when the valve body is closed (see, in particular, FIG. 3). Further, since the lower half portion of the valve body 29Va, which is located at a lower level in the gravity direction when the valve body is closed, is adapted to open toward the downstream side of the oxidant gas flow in the oxidant gas discharge channel 29, even when the liquid that has collected therein is frozen, the valve body 29Va can move (open) in a direction of removing the frozen liquid (ice) along the downstream direction of the oxidant gas flow in the oxidant gas discharge channel 29, so that the movement of the valve body 29Va when it is opened is not hindered by the frozen liquid (ice) (see, in particular, FIG. 4). Thus, the operation and opening of the valve body 29Va that is frozen and stuck is ensured, thereby ensuring the open/close performance (valve opening performance) of the pressure regulating valve 29V provided in the oxidant gas discharge channel 29.

Further, since the valve body 29Va, when closed, is disposed such that the valve body surface facing upstream of the oxidant gas flow in the oxidant gas discharge channel 29 is tilted at an angle in the range of 10 to 45 degrees relative to the vertical plane, even when liquid (water) collects at normal use as expected, the water level is below the rotating shaft 29Vb, so that the operation of the valve body 29Va can be ensured.

Furthermore, since the oxidant gas discharge channel 29 is disposed so as to be constantly tilted downward in a region of from the fuel cells 10 (or the discharge port thereof) to the pressure regulating valve 29V (or the valve body 29Va thereof), backflow of the remaining water toward the fuel cells 10 can be prevented so as to protect the fuel cells 10 (for example, prevent the cells from clogging) while drainage of the fuel cells 10 is ensured.

Although the aforementioned embodiment illustrates an example in which the pressure regulating valve 29V as a fluid control valve disposed in the oxidant gas discharge channel 29 is configured as a butterfly valve having the rotating shaft 29Vb provided in the substantially center (in the vertical direction) of the disc-like valve body 29Va thereof, it is needless to describe in detail that the configuration of the fluid control valve is not limited thereto, but, for example, the fluid control valve may have the rotating shaft 29Vb provided in a portion other than the center (in the vertical direction) of the valve body 29Va (for example, the upper end or near the upper end of the valve body 29Va), or may be configured as a poppet valve (see JP 2015-014331 A) or the like.

Although the embodiment of the present disclosure has been described in detail with reference to the drawings, the specific configuration is not limited thereto, and any design changes that may occur within the spirit and scope of the present disclosure are all included in the present disclosure.

### DESCRIPTION OF SYMBOLS

1 Fuel cell system
10 Fuel cells (fuel cell stack)
29 Oxidant gas discharge channel
29V Pressure regulating valve (fluid control valve)
29Va Valve body
29Vb Rotating shaft
29Vc Valve seat

What is claimed is:

1. A fuel cell system comprising a fluid control valve in a reactant gas discharge channel through which a reactant gas discharged from a fuel cell flows, the fluid control valve including a valve body, the valve body being adapted to open and close the reactant gas discharge channel, wherein
the valve body, when closed, is disposed so as to be tilted relative to a vertical plane so that a valve body surface facing upstream of a reactant gas flow in the reactant gas discharge channel faces up and a lower portion of the valve body that is located at a lower level in a gravity direction at least when the valve body is closed is adapted to open toward a downstream side of the reactant gas flow in the reactant gas discharge channel

2. A fuel cell system comprising a fluid control valve in a reactant gas discharge channel through which a reactant gas discharged from a fuel cell flows, the fluid control valve being adapted to open and close the reactant gas discharge channel by rotating a plate-like valve body about a rotating shaft,
wherein:
the rotating shaft is horizontally disposed, and
the valve body, when closed, is disposed so as to be tilted relative to a vertical plane so that a valve body surface facing upstream of a reactant gas flow in the reactant gas discharge channel faces up and a lower portion of the valve body that is located at a lower level in a gravity direction when the valve body is closed is adapted to open toward a downstream side of the reactant gas flow in the reactant gas discharge channel.

3. The fuel cell system according to claim 1, wherein the valve body, when closed, is disposed such that the valve body surface facing upstream of a reactant gas flow in the reactant gas discharge channel is tilted at an angle in a range of 10 to 45 degrees relative to the vertical plane.

4. The fuel cell system according to claim 1, wherein the reactant gas discharge channel is disposed so as to be constantly tilted downward in a region of from a discharge port of the fuel cell to the fluid control valve.

5. The fuel cell system according to claim 2, wherein the valve body, when closed, is disposed such that the valve body surface facing upstream of a reactant gas flow in the reactant gas discharge channel is tilted at an angle in a range of 10 to 45 degrees relative to the vertical plane.

6. The fuel cell system according to claim 2, wherein the reactant gas discharge channel is disposed so as to be constantly tilted downward in a region of from a discharge port of the fuel cell to the fluid control valve.
